(19) United States
(12) Patent Application Publication
(10) Pub. No.: US 2024/0177891 A1
(43) Pub. Date: May 30, 2024

(54) CABLE SCORING TEMPLATE

(71) Applicant: Brady Russell Topham, Washington, UT (US)

(72) Inventor: Brady Russell Topham, Washington, UT (US)

(21) Appl. No.: 18/524,540

(22) Filed: Nov. 30, 2023

Related U.S. Application Data
(60) Provisional application No. 63/385,473, filed on Nov. 30, 2022.
(60) Provisional application No. 63/480,225, filed on Jan. 17, 2023.

(51) Int. Cl. H01B 13/34; H02G 1/12

(52) U.S. Cl. CPC H01B 13/34; H02G 1/1202

(57) ABSTRACT

A cable scoring template features a body, a plurality of ridges positioned along a width of the body, a pointer, an indentation, a notch extending from the pointer to the indentation, and measurement indicators positioned along a length of the body configured to align with sites along a cable to be measured, scored, and stripped or cut. The cable scoring template may be flat or rounded, and may be of a fixed length or configured to adjust a length of the body and/or modify the placement of the plurality of ridges. The cable scoring template aids the technician in complying with safety codes and electrical regulations that mandate precise measurements and specifications to which cable must be handled and prepared during terminations.

### CROSS-REFERENCE TO RELATED APPLICATIONS

This application claims the benefit of U.S. Provisional Application Ser. No. 63/385,473, filed on Nov. 30, 2022, and further claims the benefit of U.S. Provisional Application Ser. No. 63/480,225, filed on Jan. 17, 2023, both of which are incorporated herein by reference.

### TECHNICAL FIELD

The present disclosure relates, generally, to electrical cable. In particular, the present disclosure relates to a template for measuring and scoring, or otherwise marking, electrical cable during installation.

### BACKGROUND

Cable stripping is a necessary component of nearly any electrical project and involves measuring, cutting, or otherwise prepping a cable for installation. Cables need to be processed before they can be connected with cable terminations for specific use. First, the cable is cut to the desired length using either a machine or cable cutters. Then, to strip the cable, the outer jacket is carefully removed, leaving the conductors exposed. A knife or cable stripper may be used to apply light pressure to score a circle around the jacket of the cable without cutting all the way through the cable. A special stripping tool may be used to remove the insulation from around the conductors by sliding the sheathed cable into the notch of the stripping tool that matches the cable gauge and squeezing while sliding to expose the inner wiring. Electrical cords, plastic sheathed cables, coaxial cables, internet lines, and other related wiring each require stripping and related preparation before installation.

Cable stripping is a repetitive process that is manually performed on the job site by a technician. Safety codes and electrical regulations often mandate precise measurements and specifications to which wiring must be stripped, handled, and prepared. Moreover, in order for the cable to function properly, a cable termination must also be made, creating physical and electrical connections between the cable and the terminal of the equipment, junction, or another cable, thereby facilitating the flow of electricity in the desired manner. However, measuring and preparing each cable is a time consuming process and leaves room for error.

Accordingly, there is a need for a cable scoring template that accommodates the fit of varying gauges of cables and facilitates accurate measurements, scorings, and cuts during the cable termination process, thereby reducing the time required and lowering odds of errors. The present disclosure solves these problems and others.

### SUMMARY OF EXAMPLE EMBODIMENTS

In some embodiments, a cable scoring template comprises a body having a first surface, a second surface opposite the first surface, a first end, and second end opposite the first end. The first surface comprises two or more ridges positioned along a width of the body at precise intervals corresponding to the measurements and specifications required for safely terminating an electrical cable. The cable scoring template further comprises a pointer positioned at an end of the first ridge, an indentation, and a notch or groove extending from the pointer to the indentation. Accordingly, it will be appreciated that the cable scoring template is configured to align with sites along a cable to be marked, scored, stripped, and/or cut. The body of the cable scoring template may be substantially flat or rounded to match the gauge of the wiring being prepared.

In some embodiments, a cable scoring template comprises a body having a first surface, a second surface opposite the first surface, a first end, and second end opposite the first end. The first surface comprises a plurality of ridges positioned along a width of the body at precise intervals corresponding to the measurements and specifications required for safely terminating an electrical cable. In one non-limiting example, a first ridge may be positioned two and half inches from the first end, a second ridge may be positioned seven inches from the first ridge, a third ridge may be positioned two and half inches from the second ridge, and the fourth ridge may be positioned at the second end. The cable scoring template further comprises a pointer positioned at an end of the first ridge, an indentation, and a notch or groove extending from the pointer to the indentation. Accordingly, it will be appreciated that the cable scoring template is configured to align with sites along a cable to be marked, scored, stripped, and/or cut. The body of the cable scoring template may be substantially flat or rounded to match the gauge of the wiring being prepared.

In some embodiments, the cable scoring template comprises one or more blades positioned along the plurality of ridges configured to cut the insulation of the wiring.

### BRIEF DESCRIPTION OF THE DRAWINGS

FIG. 1 illustrates a front plan view of a cable scoring template;

FIG. 2 illustrates a side elevation view of a cable scoring template;

FIG. 3 illustrates a back plan view of a cable scoring template;

FIG. 4 illustrates a back perspective view of a cable scoring template positioned along an insulation shield of a cable;

FIG. 5 illustrates a front perspective view of a cable scoring template positioned along an insulation shield of cable to mark or score the cable;

FIG. 6 illustrates a back perspective view of a cable scoring template positioned along an insulation shield of cable with a conductor exposed;

FIG. 7 illustrates a back perspective view of a cable scoring template positioned along a cable with a lug coupled to a conductor;

FIG. 8 illustrates a back plan view of a cable scoring template positioned along a cable with a lug coupled to a conductor and an insulation exposed;

FIG. 9 illustrates a front plan view of a cable scoring template;

FIG. 10 illustrates a side elevation view of a cable scoring template;

FIG. 11 illustrates a back plan view of a cable scoring template;

FIG. 12 illustrates a back perspective view of a cable scoring template positioned along an insulation shield of cable;

FIG. 13 illustrates a back perspective view of a cable scoring template positioned along a cable with a conductor and an insulation exposed;

FIG. 14 illustrates a front perspective view of a cable scoring template positioned along a cable to mark the termination body position;

FIG. 15 illustrates a front perspective view of a cable scoring template positioned along a cable with tape to mark the termination body position; and

FIG. 16 illustrates a back perspective view of a cable scoring template positioned to determine the lug connector position.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

The terms “cable,” “wire,” “wiring,” and the like, as used in the present disclosure, are intended to function interchangeably to denote any flexible thread or rod made of conductive metal.

As previously discussed, there is a need for a cable scoring template that accommodates varying gauges of cables and wires and that facilitates accurate measurements, scorings, and cuts of the cable in preparation for installation. The present disclosure solves these and other problems.

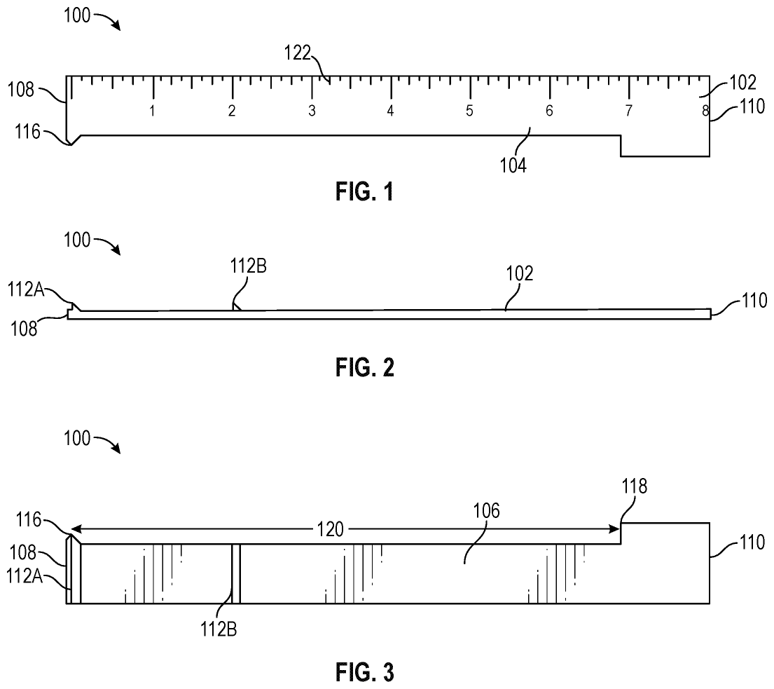

In some embodiments, as shown in FIGS. 1-8, a cable scoring template 100 comprises a body 102 having a first surface 104, a second surface 106 opposite the first surface 104, a first end 108, and a second end 110 opposite the first end 108. The body 102 may be substantially rectangular in shape with straight sides, though other shapes and/or curved sides may be used. The second surface 106 comprises two or more ridges 112A-B positioned along a width of the body 102 at precise intervals corresponding to the measurements and specifications required for safely terminating an electrical cable 114 in preparation for installation. In one non-limiting example, the interval as shown between the first and second ridges 112A-B is two inches in length, though other lengths may be used depending on the intended termination. The cable scoring template 100 further comprises a pointer 116 positioned at an end of the first ridge 112A, an indentation 118, and a notch 120 or groove extending from the pointer 116 to the indentation 118.

In some embodiments, but without limitation, a length of the notch 120 may be six and seven-eighths inches (6⅞″) in length, though other lengths may be used. The pointer 116 may be tapered or otherwise manufactured to have a fine point that is easily discernible when positioned along a length of electrical cable 114. As seen in FIG. 1, the first surface 104 may comprise measurement indicators 122 positioned along a length of the body 102 configured to align with sites along an electrical cable 114 to be scored and stripped or cut. The measurement indicators 122 positioned along the length of the body 102 may be imperial or metric measurements depending on the country or circumstance of use. For example, but without limitation, the measurement indicators 122 may begin at the first end 108 at zero inches and continue along one eighth inch (⅛″) intervals until reaching the second end 110 at eight inches (8″) in total length. While the measurement indicators 122 are shown on the first surface 104, it will be appreciated that they may also be positioned on the second surface 106 or along an edge of the body 102, thereby visible from either surface 104, 106.

In some embodiments, the cable scoring template 100 may comprise an adjustable twist buckle, a locking pin, screws, a bolt and nut, magnets, or alternative securing mechanism configured to adjust a length of the body 102 and/or modify the placement of the two or more ridges 112A-B along the body 102 relative to one another. The adjustability would enable the cable scoring template 100 to conform to the safety and regulatory requirements for a wider range of cable models and varying types of cable terminations. It will be appreciated, that a technician in the field may modify the cable scoring template 100 by loosening the adjustable twist buckle, expanding or contracting the length of the body 102 to the desired distance using, for example, two overlapping or interlocking halves of the body 102, and then fastening the two halves together by tightening the adjustable twist buckle or locking screw. Alternatively, each individual ridge 112A-B may slide along a channel of the body 102 and be fixed in place at predetermined intervals.

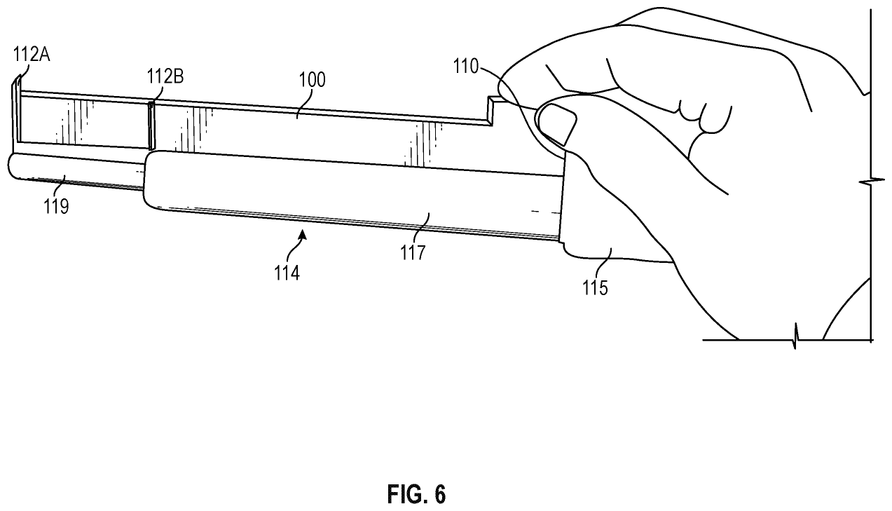

Speaking functionally, after a user has removed a length of jacketing from the cable 114 and secured the concentric wires 115 to the remaining jacketing on the cable 104 (e.g., folding or wrapping the concentric wires 115 around the remaining jacketing) using tape and mastic, the first ridge 112A indicates the cut-off length on an electrical cable 114, measured by abutting the second end 110 to the folded concentric wires 115 and using the first ridge 112A to mark the cut-off point. The second ridge 112B indicates where the insulation shield 117 and insulation 123 will be removed to expose bare conductor 119, as shown in FIG. 6.

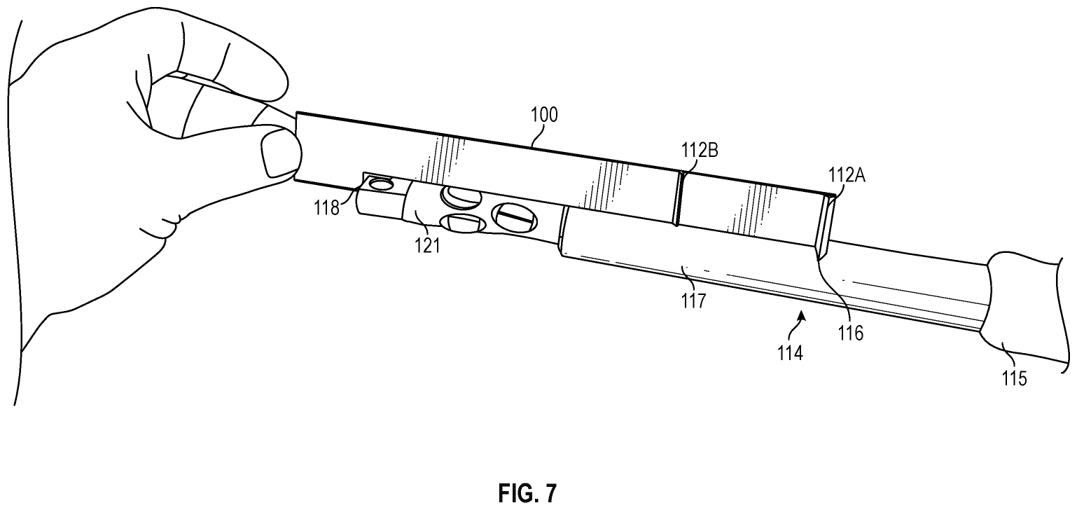

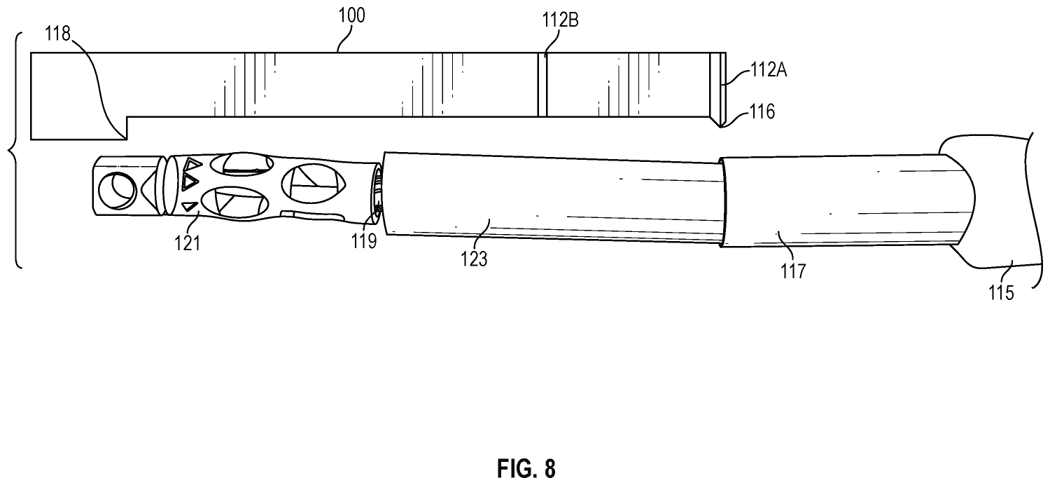

Once the bare conductor 119 is exposed, a user may crimp (or otherwise couple) a lug 121 (FIG. 7) on the conductor 119. It will be appreciated that the length of insulation shield 117 and insulation 123 removed may be sufficient to allow for room for growth of the lug 121 when crimped. Continuing reference to FIG. 7, once the conductor 119 is crimped or coupled into place, a user may abut the indentation 118 against the end of the lug 121 and mark the insulation shield 117 using the pointer 116 (such as by pressing the pointer against the insulation shield to create a mark or cut). This is used to indicate the length of insulation shield 117 to remove, thereby exposing insulation 123, as shown in FIG. 8.

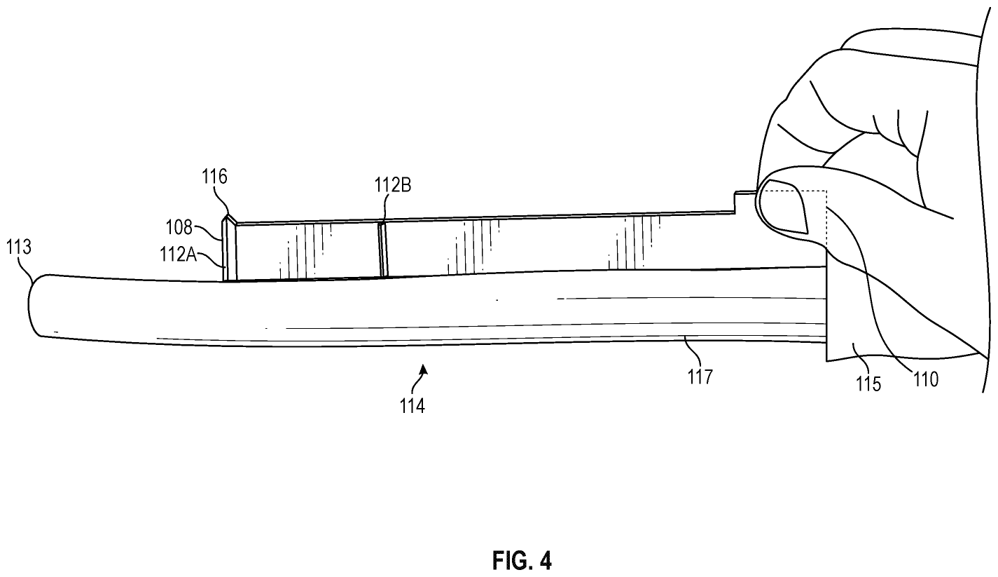

FIG. 4 demonstrates the placement of the cable scoring template 100 against the electrical cable 114. As shown, the second end 110 is positioned against concentric wires 115 that have been taped over. The first end 108 is positioned at the location of the cut-off length for the electrical cable 114. Any length of electrical cable 114 between the first end 108 and the tip 113 of the electrical cable 114 is excess length that may be removed and discarded by the user.

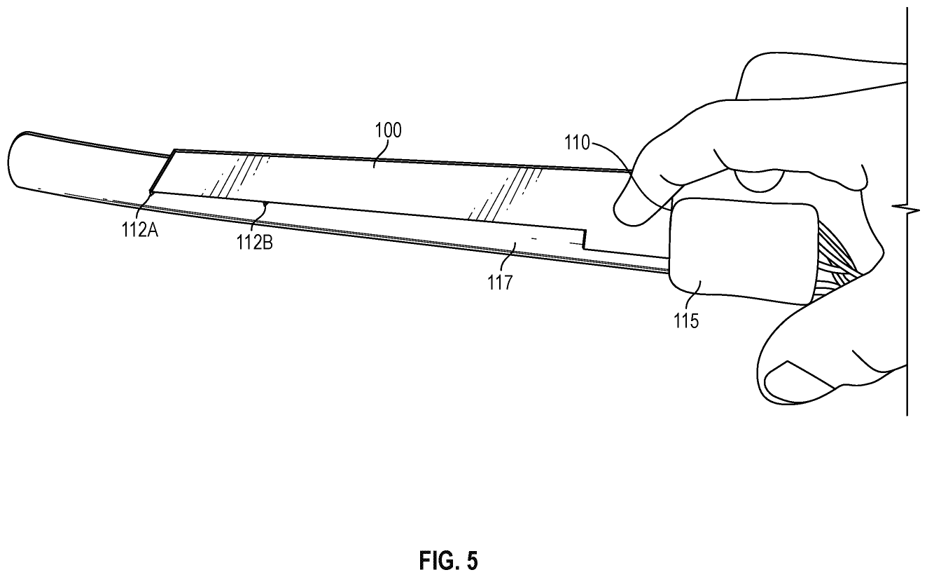

FIG. 5 shows the second surface 106 of the cable scoring template 100 placed face down against an insulation shield 117 of the electrical cable 114 with the first surface 104 facing away from the insulation shield 117. From this position, a user may firmly press the cable scoring template 100 against the insulation shield 117 and may radially rotate the cable scoring template 100 around the insulation shield 117, scoring a mark or cut into the insulation shield 117 along the first and second ridges 112A-B. A user may then use cable cutters or another tool to cut the electrical cable 114 along the scoring mark made by the first ridge 112A, creating a cutoff point.

Afterwards, a user may remove the insulation shield 117 and the insulation between the scoring marks made between the first ridge 112A and the second ridge 112B to expose a conductor 119 as best seen in FIG. 6. As shown, the cable scoring template 100 is repositioned along the length of the electrical cable 114 to verify that the length of the exposed conductor 119 is two inches (or other pre-determined length), as indicated by the distance between the first ridge 112A and the second ridge 112B.

FIG. 7 illustrates the placement of a lug 121 on the exposed conductor 119 (covered by the lug 121 in this view) and the subsequent measurement using the cable scoring template 100 from the tip of the lug 121 to a scoring location along the insulation shield 117, indicating the end of the insulation 123 exposure. After a user has crimped the lug 121 on the conductor 119, a user positions the indentation 118 along the tip of the lug 121 and extends the cable scoring template 100 along the length of the electrical cable 114, scoring a mark into the insulation shield 117 at the location of the first ridge 112A using the pointer 116 to score the insulation shield 117. FIG. 8 shows the finished termination of the electrical cable 114 with the insulation 123 exposed. A user may then install the termination kit or elbow provided by the manufacturer to finalize preparation of the electrical cable for installation.

It will be appreciated that by utilizing the cable scoring template 100, the need to measure every cut with a tape measure, ruler, or other device can be avoided. Additionally, a user is able to score the cable 114 using the cable scoring template 100, which avoids a user accidentally cutting too deep (e.g., cutting through insulation 123 when marking insulation shield 117) when using a pocketknife or other sharp object to score the cable 114. Accordingly, the cable scoring template 100 allows for faster, safer, and consistent preparation of cables by a user.

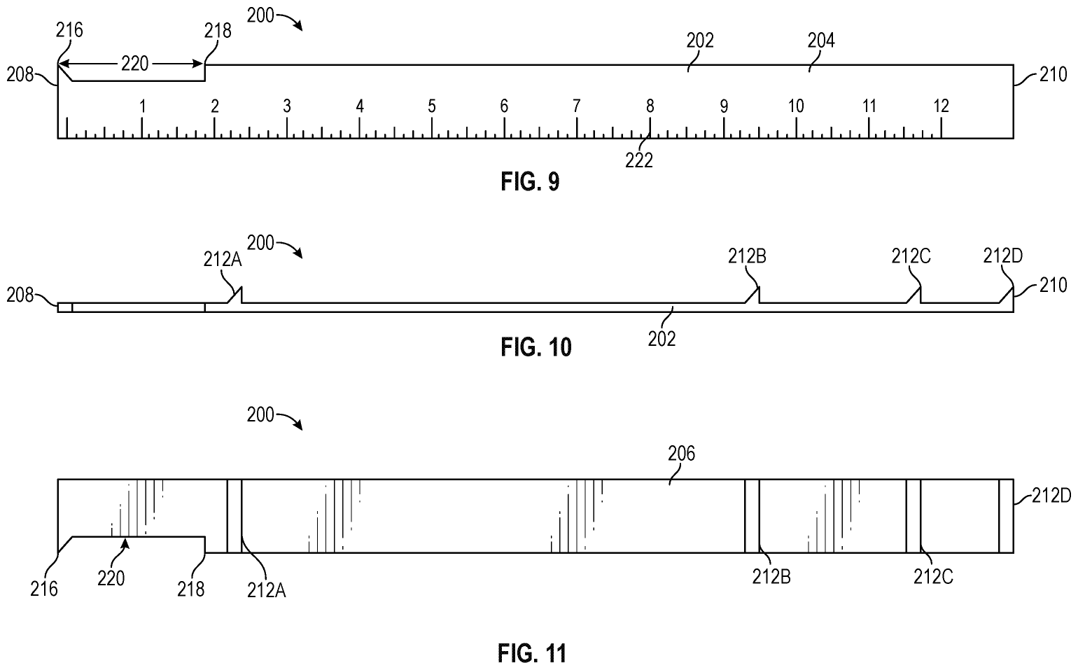

In some embodiments, as shown in FIGS. 9-16, a cable scoring template 200 comprises a body 202 having a substantially rectangular shape with a first surface 204, a second surface 206 opposite the first surface 204, a first end 208, and a second end 210 opposite the first end 208. The second surface 206 comprises a plurality of ridges 212A-D positioned along a width of the body 202 at precise intervals corresponding to the measurements and specifications required for safely terminating an electrical cable 214 in preparation for installation. The length of the intervals between the plurality of ridges 212A-D may vary depending on the intended termination.

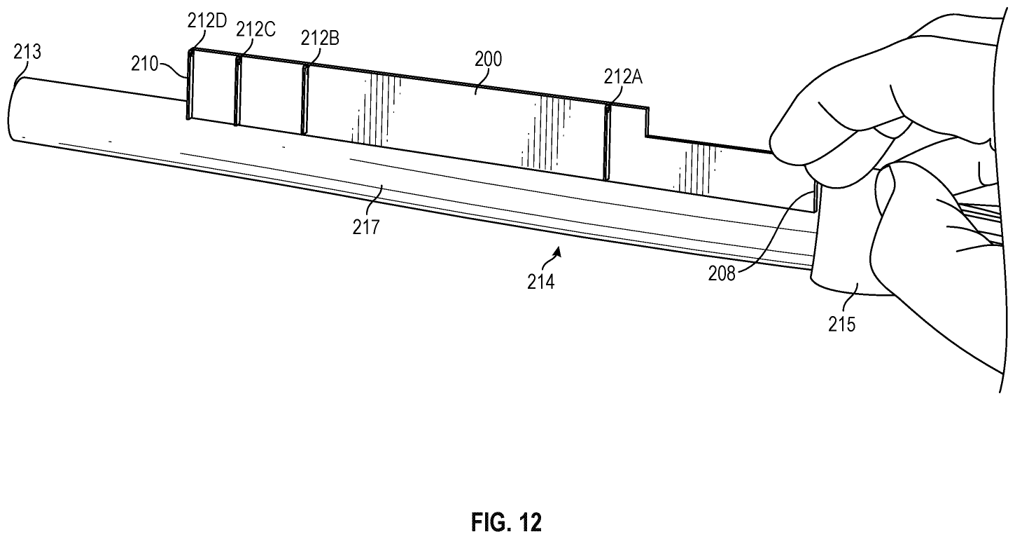

The cable scoring template 200 further comprises a pointer 216 extending along a side of the first end 208, an indentation 218, and a notch 220 or groove extending from the pointer 216 to the indentation 218. For example, in some embodiments, the notch 220 may be two inches in length, though other lengths may be used depending on the type of termination for the electrical cable 214 (FIG. 12) being utilized. Moreover, the pointer 216 may be positioned along the first end 208 of the cable scoring template 200 two and half inches from the first ridge 212A, though the distance between the pointer 216 and the first ridge 212A may vary depending on the cable and termination specifications. The pointer 216 may be tapered or otherwise manufactured to have a fine point that is easily discernible when positioned along a length of electrical cable 214.

As seen in FIG. 9, the first surface 204 may comprise measurement indicators 222 positioned along a length of the body 202 configured to align with sites along an electrical cable 214 to be scored and stripped or cut. The measurement indicators 222 positioned along the length of the body 202 may be imperial or metric measurements depending on the country or circumstance of use. For example, the measurement indicators 222 may begin at the first end 208 at zero inches and continue along one eighth inch (⅛″) intervals until reaching the second end 210 at approximately twelve to thirteen inches (12-13″) in total length, although the length and intervals may be altered without departing herefrom. While the measurement indicators 222 are shown on the first surface 204, it will be appreciated that they may also (or in the alternative) be positioned on the second surface 206 or along an edge of the body 202, thereby visible from either surface 204, 206.

Referring to FIG. 12, and speaking functionally, the first end 208 starts the layout, or in other words, indicates a reference point for the use of the cable scoring template 200 when positioned against folded concentric wires 215. The second ridge 212B may be positioned as to align with the end of an insulation cutoff point when holding the first end 208 against folded concentric wires 215 prepared along the length of electrical cable 214. The third ridge 212C may be positioned as to align with the end of the conductor length (cutoff length) in some models of wiring. The fourth ridge 212D may be positioned as an alternate cutoff point when holding the first end 208 against the concentric wires 215. It will be appreciated that the length and width of the cable scoring template 200 may vary between embodiments depending on the differing models of electrical cable 214 used and the type of termination being completed.

FIG. 12 demonstrates the placement of the cable scoring template 200 against the insulation shield 217 of electrical cable 214. As shown, the first end 208 is positioned against concentric wires 215 that have been taped over with mastic while the second end 210 is positioned at the location of the cut off length for the electrical cable 214. Any electrical cable 214 between the second end 210 and the tip 213 of the electrical cable 214 is excess length that may be removed by the user.

From here, a user may then position the cable scoring template 200 with second surface 206 against the insulation shield 217 of the electrical cable 214 with the first surface 204 facing away from the insulation shield 217. From this position, a user may firmly press the cable scoring template 200 against the insulation shield 217 scoring a mark or cut into the insulation shield 217 along the plurality of ridges 212A-D. It will be appreciated that the plurality of ridges 212A-D may be configured with an edge capable of marking or scoring, as required. A user may then use cable cutters, a knife, or another tool to cut the electrical cable 214 along the scoring made by the third or fourth ridges 212C-212D, respectively, creating a cutoff point. A user will select the cutoff point using ridges 212C or 212D based upon whether a single-crimp or double-crimp lug will be used.

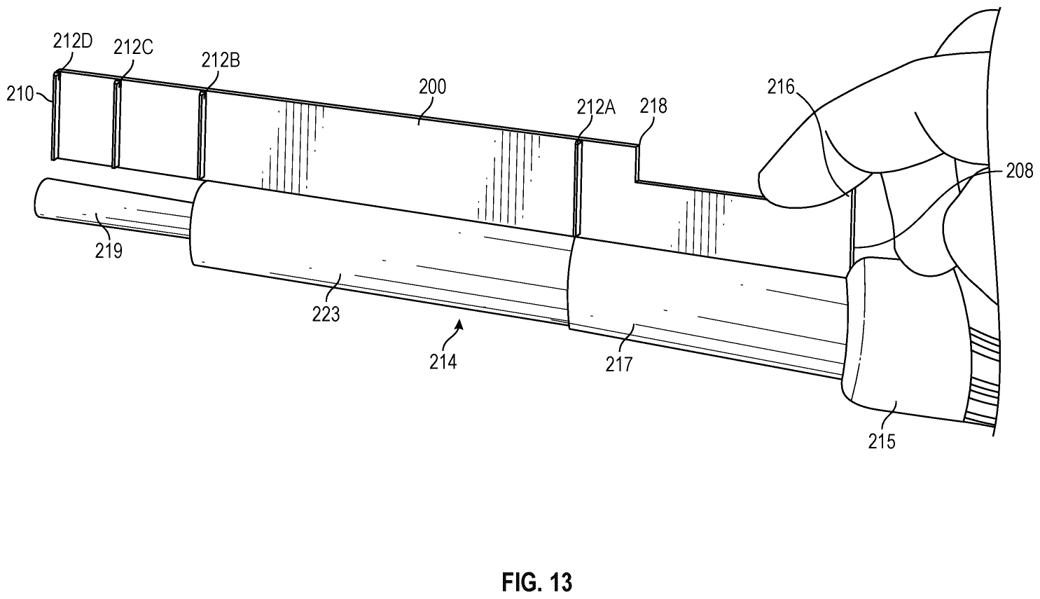

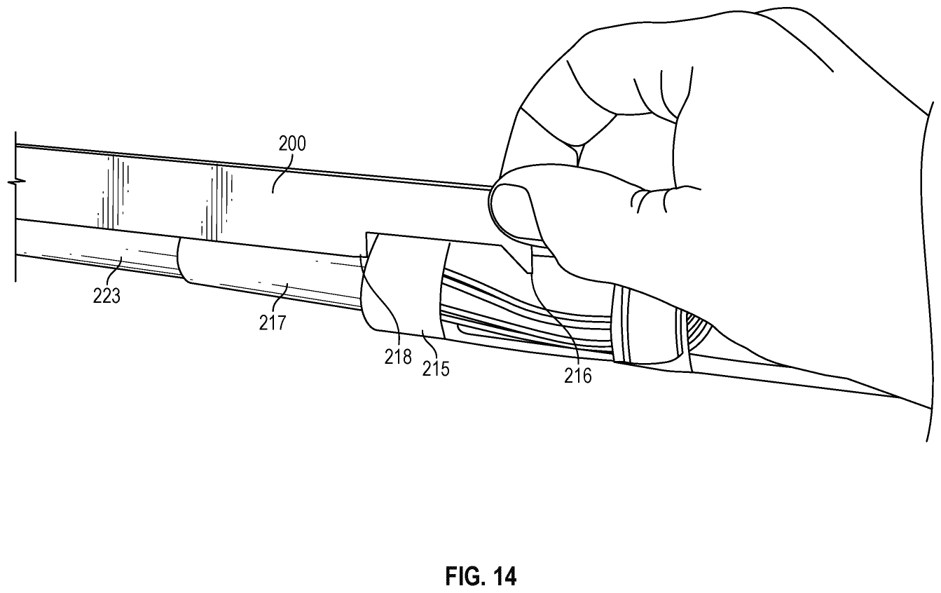

Afterwards, as best seen in FIG. 13, a user may remove the insulation shield 217 and insulation 223 between the scoring marks made between the fourth ridge 212D and the second ridge 212B to expose the conductor 219. Once a lug is coupled to the conductor 219, a user may remove the insulation shield 217 between the first ridge 212A and the second ridge 212B to expose the insulation 223. The electrical cable 214 is now scored, stripped, and cut at appropriate measurements in preparation to begin a termination.

As seen in FIG. 14, a user may position the indentation 218 at a top of the folded concentric wires 215 with the pointer 216 positioned away from the lug and towards the termination body of the electrical cable 214. The pointer 216 indicates the location where tape and/or mastic may be placed to further secure the concentric wires 215 and to indicate the placement of the termination body.

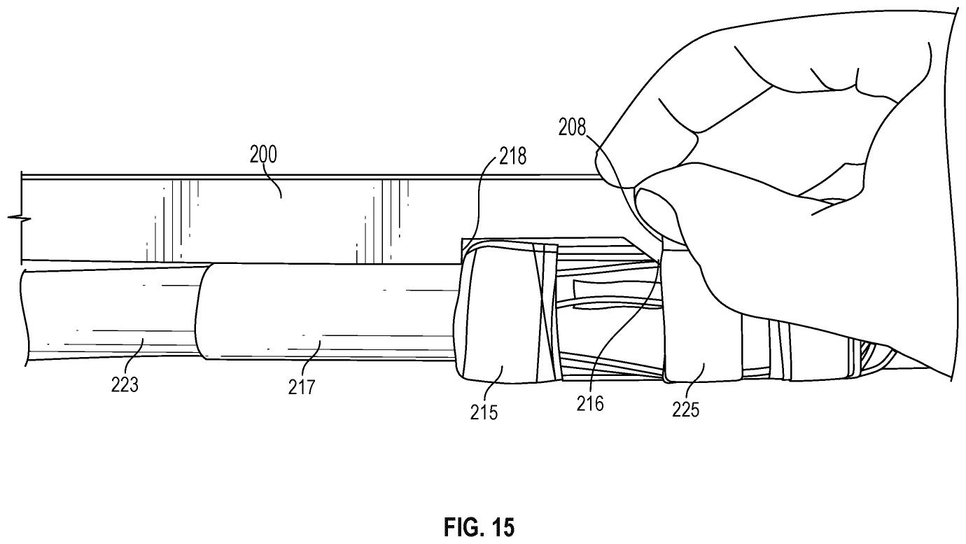

FIG. 15 shows the placement of the tape 225 over the concentric wires at the appropriate spacing in conformance with safety specifications. It will be appreciated that the notch 218 provides a cutout or notch 220 that helps conform to the tape already in place over the folded concentric wires 215, enabling a better formfactor to the electrical cable 214.

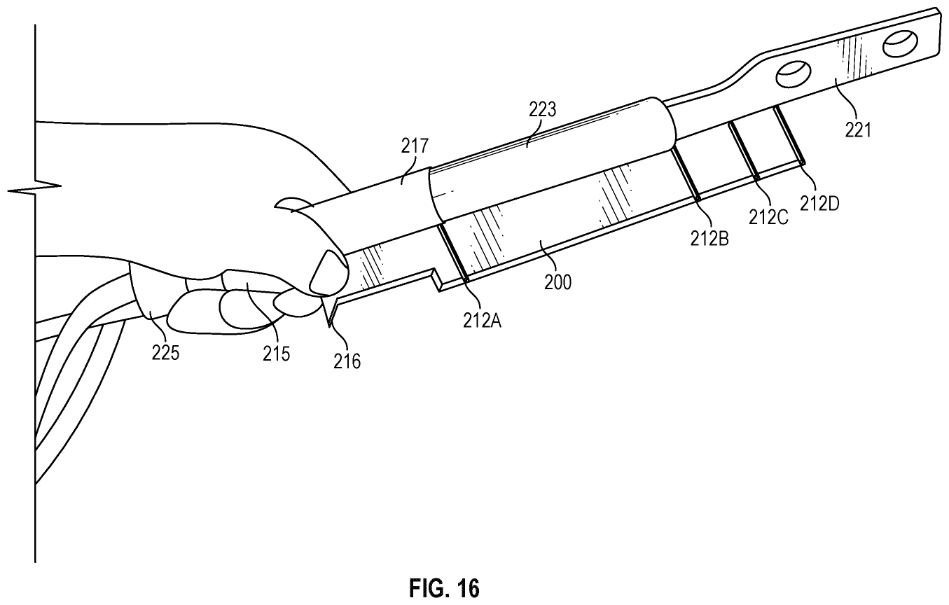

FIG. 16 shows the cable scoring template 200 wherein a lug 221 connector is crimped over the conductor 219 (not visible in this view). The cable scoring template 200 may also be used to measure the spacing for growth of the lug 221 when crimped to the conductor 219, typically between 1/16-½ inches, depending on whether the lug 221 requires one or two crimps. For example, the distance between the third ridge 212C and the second ridge 212B may indicate the distance compatible for one crimp in the lug 221 while the combined distance between the second ridge 212B and the fourth ridge 212D may indicate the distance needed for two crimps in the lug 221. While crimping is discussed, it will be appreciated that other known methods of coupling the lug 221 may be used without departing herefrom. In some embodiments, the cable scoring template 200 comprises intervals between the plurality of ridges 212A-D that accommodate this anticipated growth without additional measurements being taken at this stage of the installation process.

In some embodiments, the positioning of the plurality of ridges 212A-D may be adjusted using a spring actuated button, a screw, a sliding mechanism along a rail, or other fastening mechanism to adjust the positioning of the plurality of ridges 212A-D. In said embodiments, the user may establish the relative positioning of the plurality of ridges 212A-D with respect to the particular electrical cable 114, 214 or wiring being used and the project being completed. The body 102, 202 of the cable scoring template 100, 200 may be substantially flat or rounded to match the gauge of the electrical cable 114, 214 being prepared. It is contemplated that a rounded body of the cable scoring template 100, 200 may be placed over the wiring to better grip the electrical cable 114, 214 when making measurements and then slide along the wiring between scoring, stripping, or cutting.

In some embodiments, as shown, the plurality of ridges 112A-B, 212A-D may be shaped or configured so as to form an edge capable of scoring or otherwise marking the cable 114, 214. In some embodiments, the cable scoring template 100, 200 may comprise one or more blades positioned along the plurality of ridges 112A-B, 212A-D to cut the various layers (e.g., insulation shield, insulation, etc.), in addition to making the marks or scoring for the measurements. In some embodiments, the plurality of ridges 212A-D, as well as the pointer 116, 216 may comprise a marker or chalk configured to indicate the locations where the insulation should be cut, or where the jacketing marked, without scoring.

Therefore, it will be appreciated from the foregoing that the cable scoring template 100, 200 overcomes limitations in the prior art by allowing a user to quickly measure, score, and prepare a cable.

It will be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A cable scoring template, comprising:
a body;
a first surface;
a second surface comprising a plurality of ridges;
a pointer at a first end;
an indentation interposed between the first end and a second end; and
a notch extending from the pointer to the indentation.

2. The cable scoring template of claim 1, wherein the plurality of ridges comprises a first ridge at the first end and a second ridge interposed between the first end and the second end.

3. The cable scoring template of claim 2, wherein the distance between the first ridge and second ridge is two inches.

4. The cable scoring template of claim 1, wherein the plurality of ridges are each configured to score a cable.

5. The cable scoring template of claim 1, wherein the plurality of ridges comprises a first ridge at the first end, a second ridge and a third ridge interposed between the first end and second end, and a fourth ridge at the second end.

6. The cable scoring template of claim 5, wherein the indentation is interposed between the first and second ridges.

7. The cable scoring template of claim 1, further comprising measurement indicators.

8. A method of using a cable scoring template to score a cable, the method comprising:
stripping a jacket of the cable to a desired length to expose a plurality of concentric neutral wires;
folding the concentric neutral wires around a remaining jacket portion, thereby exposing an insulation shield;
positioning a second end of the cable scoring template against the folded concentric neutral wires with a second surface comprising a plurality of ridges against the insulation shield;
pressing and sliding the cable scoring template radially against the insulation shield to thereby score the insulation shield;
removing the insulation shield and an insulation between a first ridge and a second ridge of the plurality of ridges to expose a conductor;
coupling a lug to the conductor;
abutting an indentation of the cable scoring template against a tip of the lug;
using a pointer, scoring the insulation shield; and
removing the insulation shield between the conductor and the scored insulation shield to expose a layer of insulation.

9. A method of using a cable scoring template to score a cable, the method comprising:
stripping a jacket of the cable to a desired length to expose a plurality of concentric neutral wires;
folding the concentric neutral wires around a remaining jacket portion, thereby exposing an insulation shield;
positioning a second end of the cable scoring template against the folded concentric neutral wires with a second surface comprising a plurality of ridges against the insulation shield;
pressing and sliding the cable scoring template radially against the insulation shield to thereby score the insulation shield;
removing the insulation shield between a first ridge and a fourth ridge of the plurality of ridges to expose an insulation;
removing the insulation between a second ridge and the fourth ridge of the plurality of ridges to expose a conductor;
coupling a lug to the conductor;
abutting an indentation of the cable scoring template against the folded concentric neutral wires;
using a pointer, scoring the remaining jacket portion; and
taping the scored remaining portion to indicate the position of a termination body.
